(19) United States
(12) Patent Application Publication
(10) Pub. No.: US 2023/0089184 A1
(43) Pub. Date: Mar. 23, 2023

(54) CUTTING MACHINE KNIFE FOR FOOD PRODUCTION

(71) Applicants: BE MASCHINENMESSER GMBH & CO. KG, Spreenhagen (DE); HOCHSCHULE ANHALT, Köthen (DE)

(72) Inventors: Wolfram SCHNÄCKEL, Südharz/Stolberg (DE); Ingo MICKLISCH, Halle (Saale) (DE); Sebastian KNUTH, Grünheide (Mark) (DE); Matthias FLEISCHHAUER, Steinhöfel (DE)

(21) Appl. No.: 17/795,740

(22) PCT Filed: Jan. 27, 2021
(86) PCT No.: PCT/EP2021/051850

§ 371 Date: Jul. 27, 2022

(30) Foreign Application Priority Data
Jan. 27, 2020 (DE) 10 2020 101 898.3

(51) Int. Cl. B02C 18/20; B02C 18/06

(52) U.S. Cl. CPC B02C 18/20; B02C 18/065

(57) ABSTRACT

The invention relates to a cutting machine knife for food production, having a cutting body and a fastening section for fastening the cutting machine knife to a rotary drive, wherein the cutting body has two side faces which run at least approximately parallel to one another, and at least one knife with a cutting edge on a front edge, in relation to an intended rotation direction during operation, of the cutting body. According to the invention it is provided that the cutting body also has at least one striking edge, which is formed by an end face, which is inclined by an angle of between 60° and 120°, preferably between 70° and 90°, relative to a rotation plane of the cutting machine knife, and extends transversely to the rotation plane of the cutting machine knife in relation to the intended rotation direction between two flat faces which run at an angle between 0° and 35° to the rotation plane, wherein a transition from the end face to the flat face trailing this end face in the rotation direction is sharp-edged.

The invention relates to a cutting machine knife for food production, for comminuting and emulgating fibrous, amorphous products, particularly meat and fish, by means of a combination of cutting and beating.

Mechanical comminuting and emulgating processes play a decisive role in the food industry, wherein the cutter in particular constitutes a basic machine in the food production. In these machines, rough biological materials, that is, mainly meat and fish, are comminuted by rapidly rotating cutting machine knives and emulgated by the friction at them. However, the performance is limited by the shape of the blades or the formation and surface properties of the side surfaces of conventional cutting machine knives.

For example, in the production of boiled and cooked sausage meat, by means of the cutting action of the cutting machine knives during the processing time, the raw material fibers are supposed on the one hand to be comminuted and on the other hand the proteins contained therein are supposed to be broken down and emulgated. In the later end product, all individual components contained in the starting material, particularly the meat fibers, fat particles and water, are supposed to be combined by emulgated proteins in a manner which is as homogeneous as possible. Thus, quality deficits in the end product, such as water or jelly separation, can be avoided. For an effective bonding of the individual components, it is necessary in particular for sufficient dissolved proteins to be present in order, in the subsequent growing process, to be able to form a stable protein scaffolding. For reasons of the cutting action of the cutting machine knives and the tear-cuts which form, the proteins from the meat fibers enter into solution. For a best-possible bonding of the individual components, a high degree of mixing and emulgation, caused primarily by friction of the individual components or their particles among one another, and also with the cutting machine knives, is necessary.

Here, however, care must be taken that the particles are not comminuted too finely in the course of the processing time, since otherwise the dissolved proteins would no longer be sufficient for a coating of the individual components, and thus it would not be possible for a stable bonding of the individual components to result. A processing process which is too long results in particular in a heating of the particles of the individual components which is detrimental to the quality of the end product and which is generated predominantly by friction at the rapidly rotating cutting machine knives. As a result, an undesired denaturation of the present proteins starts already during the comminuting process. In the later heating procedure, these proteins are no longer available for the subsequent bonding of previously non-bonded particles of the individual components. For this reason, in order to create highquality end products, a specific ratio between comminuting and emulgating performance of the cutting machine knives is vital, such that a ratio with regard to the obtained particle size and the meat temperature results which is suitable for the complete and stable bonding of the individual components.

In order to increase the comminuting performance, in DE 10 2015 200 878 A1 it is proposed to introduce openings with integrated knives into the cutting body of the cutting machine knife. In order to increase the emulgating performance of cutting machine knives, it is proposed in turn in EP 1 985 369 B1 that indentations be introduced into the cutting body.

It is the goal of the invention to create a more powerful cutting machine knife.

The preceding task is solved according to the invention by a cutting machine knife with the characteristics of claim 1.

Accordingly, a cutting machine knife is provided for food production which has a cutting body and a fastening section for fastening the cutting machine knife to a rotary drive, of which the cutting body has two side faces which run at least approximately parallel to one another, and at least one knife with a cutting edge on a front edge, in relation to an intended rotation direction during operation, of the cutting body. With the characteristic “side faces of the cutting body running approximately parallel to one another”, for example, the case is also supposed to be included that one side of the cutting body is conical in form, such that the cutting machine knife becomes flatter towards the outer radius. In the fastening section, the side faces are preferably precisely parallel to one another.

According to the invention, with regard to the cutting machine knife, it is provided that the cutting body also has at least one striking edge which is formed by an end face, inclined relative to a rotation plane of the cutting machine knife in relation to the intended rotation direction, between two flat faces—specifically one flat face leading the end face in the rotation direction and one flat face trailing the end face in rotation direction. The inclination angle of the end face forming the striking edge is between 60° and 120°, preferably between 70° and 90° relative to the rotation plane of the cutting machine knife. The flat faces, between which the end face forming the striking edge runs, extend at an angle of between 0° and 35° to the rotation plane. The transition from the end face forming the striking edge to the flat face trailing this end face in rotation direction is sharp-edged.

The invention includes the knowledge that too small particles should not result from the individual components in the comminuting process, so that the dissolved proteins are sufficient for a homogeneous coating and bonding of the particles of the individual components. It has here been proven that slightly larger and fibrous particles bond better and the quality of the end product is increased. Fibrous particles of this sort form when a blunt striking edge impacts rapidly on the individual components, that is in particular when the striking edge impacts on the meat fibers. Furthermore, the proposed altered surface topography of the cutting machine knife results, for reasons of the at least one striking edge, in an increase in the emulgating performance and thus a reduction in the necessary processing times of the supplied material, that is, also in an advantageous reduced end temperature of the sausage meat, and in energy savings. Furthermore, the altered surface topography of the cutting machine knife has the effect of an improvement in quality with regard to the resulting product.

A striking edge can in particular be formed by an end face, projecting perpendicularly to the outside from one of the flat faces, which is inclined such that the end face and the flat face enclose an angle between them which is less than or equal to 90°. End faces of the cutting machine knife are such faces of the cutting machine knife which are visible in one view counter to the rotation direction of the cutting machine knife and are inclined at an angle of between preferably 70° and 90° to the rotation plane.

Flat faces of the cutting machine knife are for example its side faces, but also faces which are only slightly inclined with respect to the rotation plane of the cutting machine knife, such as e.g. faces in the region of the knife.

Preferably, the flat face which trails the end face forming the striking edge in the intended rotation direction runs at an angle of between 0° and 5° to the rotation plane of the cutting machine knife. Preferably, also the transition from the end face to the flat face running in front of this end face in rotation direction is sharp-edged.

Preferably, the cutting body has one, but preferably at least three elevations on a flat face. The front face—in relation to an intended rotation direction during operation—of the at least one elevation, that is its end face, forms an additional striking edge. Preferably, several elevations, each forming a striking edge, are formed on a flat face of the cutting body, wherein all elevations forming a striking edge are located on precisely one flat face of the cutting body. The flat face on which the elevations are arranged can for example be a side face of the cutting body and is preferably the incoming flow side of the cutting body, that is the side from which goods to be comminuted flow onto the cutting body during operation. The second flat face of the cutting body, opposite to the first flat face with the elevations, that is, preferably, the outgoing flow side, thus preferably does not have any elevation forming a striking edge. As a result, the increase in the number of elevations results in an increased number of available striking edges. This has an advantageous effect on the defibering and emulgating performance of the cutting machine knife.

According to an embodiment variant, it is provided that the elevations have a frustoconical geometry, wherein the elevations at the transition to the flat face have a smaller diameter than at their oppositely-situated ends. This means, the frustoconical elevations are oriented with the cover surface in the direction of the corresponding flat face, the comparatively larger basic surface thus points away from the flat face of the cutting body.

Alternatively or additionally, elevations can also be provided, the shape of which is equal to a preferably three-sided prism or a pyramid standing on its head, wherein the cross-sections of these elevations running parallel to the flat face preferably have a rectangular shape. This rectangular shape is preferably designed such that the triangle has an acute angle which points in the rotation direction of the cutting machine knife.

Alternatively or additionally, elevations can also be present which have the shape of ribs which protrude from a flat face of the cutting body. The rib-shaped elevations are preferably arranged in a curve which at least approximately follows the shape of an arc, the midpoint of which is the rotational axis of the cutting machine knife during operation.

Additionally or alternatively, an end face extending—starting from the fastening section of the cutting machine knife—along the blade of the cutting machine knife can be provided as a striking edge which extends approximately until the radial end of the cutting body.

With reference to the at least one such striking edge running along the blade of the cutting machine knife, it can further be provided that the cutting body of the cutting machine knife has a further striking edge which is geometrically at least similar to the first striking edge. This further striking edge can be arranged downstream of the first striking edge, in relation to the intended rotation direction of the cutting knife during operation. Preferably, the further striking edge adjoins on the flat face trailing the first striking edge. The flat face trailing the further striking edge in rotation direction is preferably a side face of the cutting machine knife. This means that in this variant, the first and the further striking edge are formed on precisely one flat face of the cutting machine knife. This can be a flat face facing the flow of sausage meat or the flat face opposite to this flat face.

In order to increase the emulgating performance of the cutting machine knife, and thus to shorten the necessary processing time of the supplied material, it can in addition be provided that the cutting body has on the first and the second side face in each case a first striking edge and a further striking edge adjoining the flat face trailing the first striking edge. This means that in this variant of the cutting machine knife, on the cutting body, in each case two striking edges are formed on in each case one flat face of the cutting body, that is, on the flat side which faces the flow of sausage meat and on the opposite flat side. In total, this variant has as a result a total of four striking edges.

With reference to the variant with two striking edges, that is, also with reference to the variant with four striking edges, it can be provided that the angle enclosed between the rotation plane of the cutting machine knife and the first striking edge differs from the angle enclosed between the rotation plane of the cutting machine knife and the further striking edge. Preferably, the two or four striking edges can extend—starting from the fastening section of the cutting machine knife—in each case along the blade of the cutting machine knife as far as the radial end of the cutting body.

In addition, the invention includes the knowledge that the stability of the cutting machine knife increases when the first striking edge and/or the further striking edge extends along the course of the blade of the cutting body on the first and/or the second flat side as far as the fastening section of the cutting machine knife.

With a view to the further design of the cutting machine knife, it can furthermore be provided that the cutting edge of the blade on the cutting body is formed by a ground section on the flat face of the cutting body which does not have any elevations which form in each case a striking edge. This means that the cutting body is ground on the side facing away from the flat face having the elevations in order to form the cutting edge of the cutting body. In relation to the rotation direction intended during operation of the cutting machine knife, in connection with the grinding, it can in addition be provided that the at least one striking edge adjoins on the ground section. Thus, the cutting edge ensures advantageously an improved comminution of connective tissue contained in the supplied material, since this cannot be accessed for a comminution by means of striking edges. By means of a reduction in the particle size of the connective tissue, an improved sensory property of the end product is achieved. The further striking edge increases advantageously the defibering performance of the cutting machine knife. Alternatively, it can be provided that a further flat face is arranged between the ground part and the at least one striking edge. Thus, in relation to the intended rotation direction, the ground part is spaced from the at least one striking edge by the further flat face.

In addition, it is advantageous when the cutting body of the cutting machine knife has additional breakthroughs. These breakthroughs form openings which extend from the one flat side to the other flat side of the cutting body. Preferably, the cutting body has additional indentations. These indentations are preferably arranged in one of the flat faces of the cutting body which faces the flow of sausage meat and/or which has the elevations. Both the breakthroughs and the indentations can have a circular geometry. However, this does not exclude other geometries for the breakthroughs and the indentations. Such indentations and breakthroughs in the cutting body favor the formation of a desired turbulent flow of sausage meat. Thereby, the mixing and emulgation of the sausage meat can be improved.

An elevation, a breakthrough and an indentation can be combined spatially as functional elements to form a functional group. Here, the functional elements can be arranged in a row behind one another in relation to the rotational direction intended during operation. This does not exclude a different arrangement of the functional elements. For example, the functional elements can also be arranged behind one another—in relation to the rotation direction intended during operation—in a circular curve relative to a rotational axis of the cutting machine knife. In relation to the end face of the cutting body, preferably initially an indentation is provided which is followed by a breakthrough which is in turn followed by an elevation. Furthermore, the functional elements of a functional group can partially overlap in each case, wherein the breakthrough overlaps the indentation to an extent that the cover surface of the frustoconical elevation overlaps the breakthrough.

With regard to the further design of the cutting machine knife, it is furthermore provided that a number of functional groups is arranged along a course of the cutting edge. Preferably, the functional groups have in each case the same distance from one another in radial direction of the cutting body. In addition, depending on the available width of the cutting body in rotation direction, several functional groups can be arranged behind one another in rotational direction.

A functional group can also contain fewer than three functional elements, for example only an elevation and a breakthrough, but no indentation. A functional group can also contain fewer than three functional elements, for example only an elevation and a breakthrough, but no indentation. In this context, it can in addition be provided that the variants of the cutting machine knife, with two striking edges on one flat side, or with respectively two striking edges on the first and the opposite second flat face extended along the cutting edge, have a number of functional groups.

The invention will now be explained in more detail on the basis of an embodiment example depicted schematically in a figure.

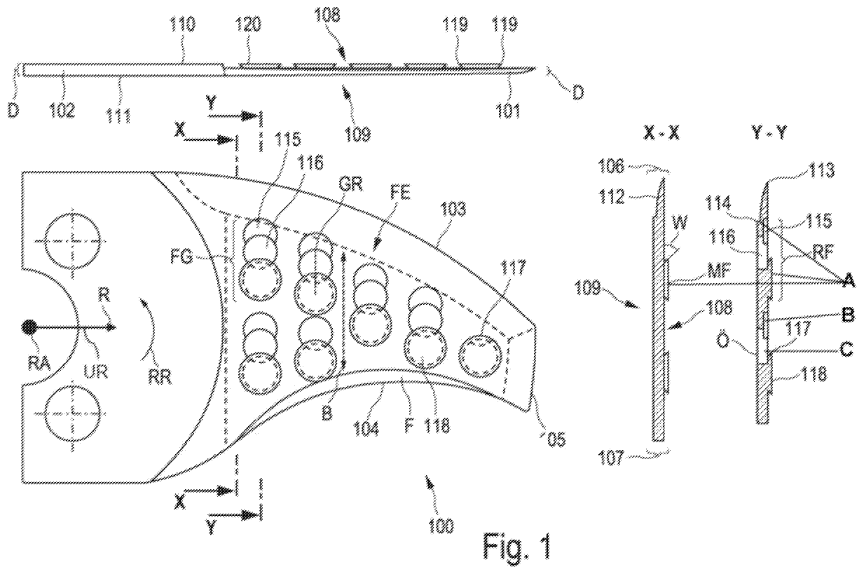

FIG. 1 Views and sectional views of a first embodiment example of a cutting machine knife according to the invention;

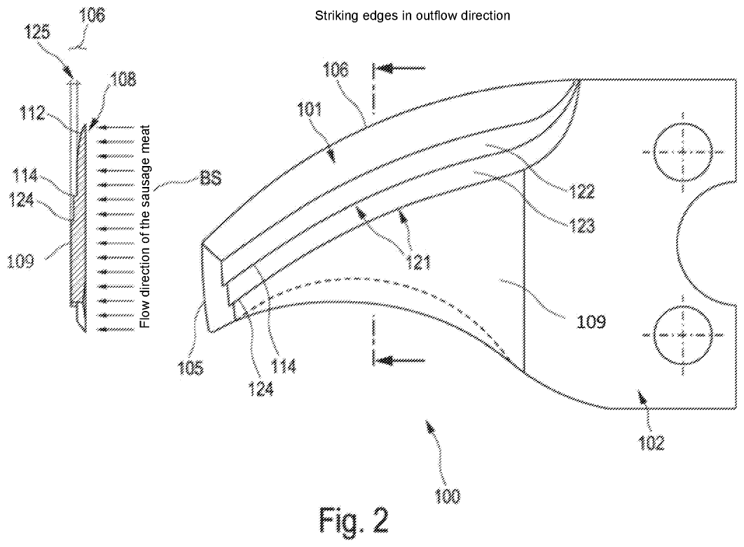

FIG. 2 Views and sectional views of a second embodiment example of a cutting machine knife according to the invention;

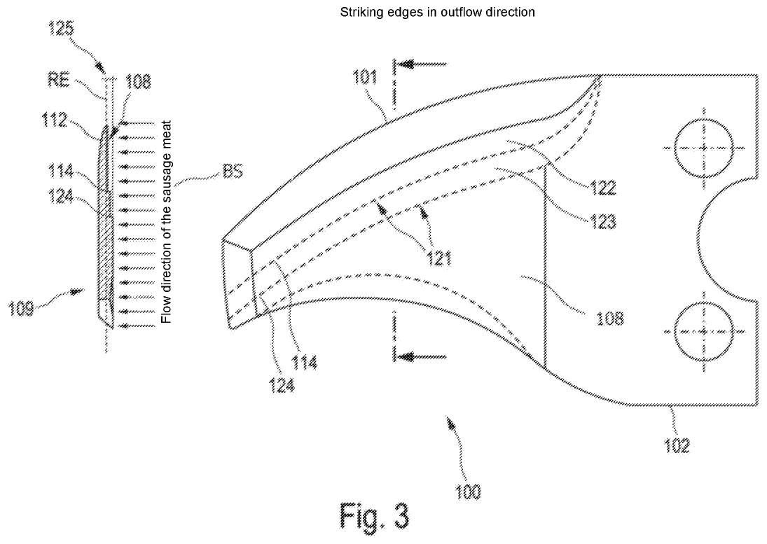

FIG. 3 Views and sectional views of a third embodiment example of a cutting machine knife according to the invention;

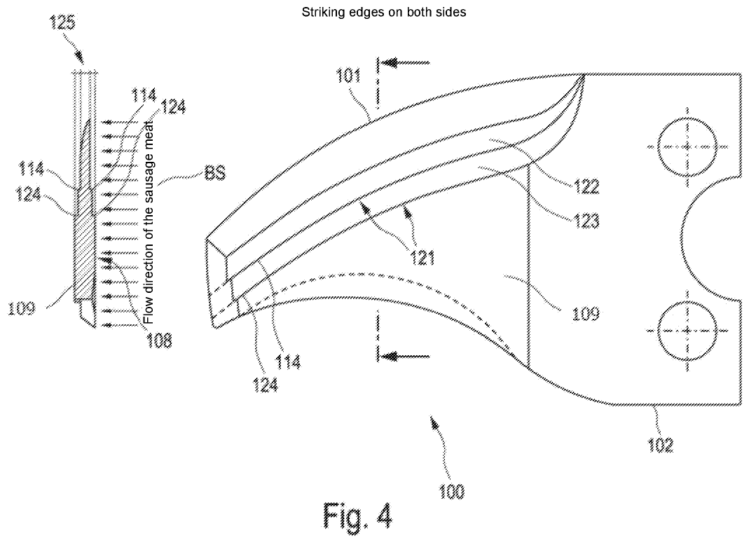

FIG. 4 Views and sectional views of a fourth embodiment example of a cutting machine knife according to the invention; and

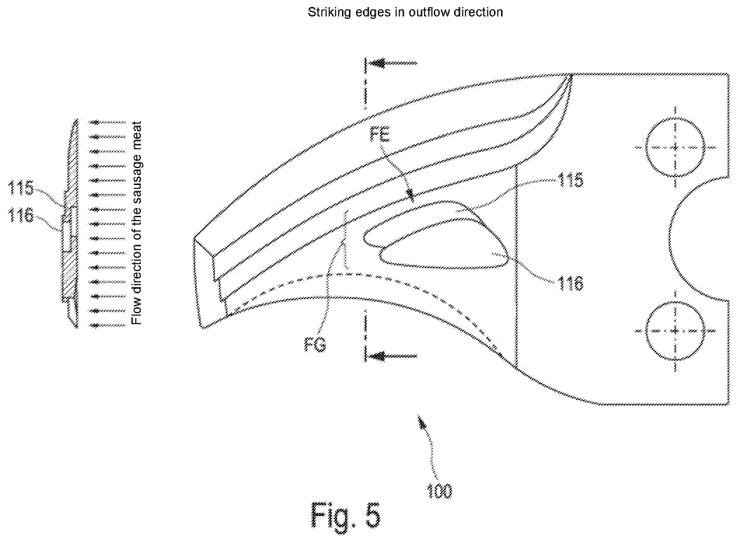

FIG. 5 Views and sectional views of a fifth embodiment example of a cutting machine knife according to the invention;

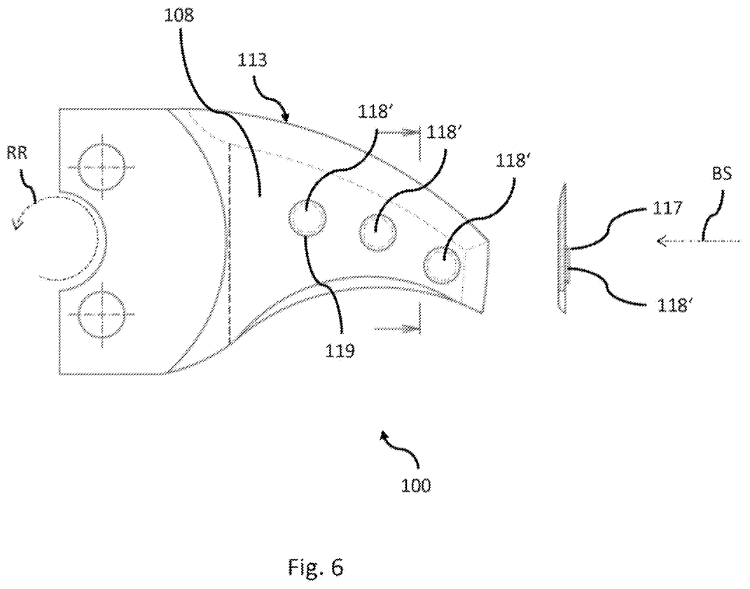

FIG. 6 Views and sectional views of a sixth embodiment example of a cutting machine knife according to the invention;

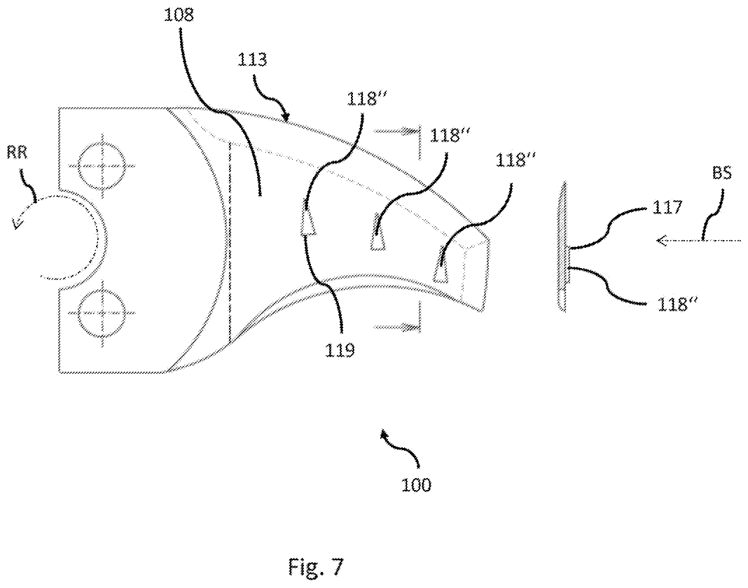

FIG. 7 Views and sectional views of a seventh embodiment example of a cutting machine knife according to the invention; and

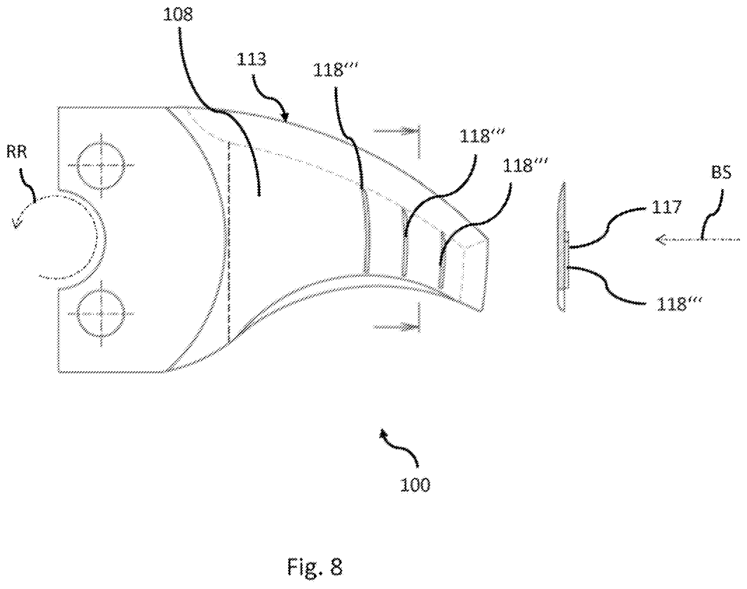

FIG. 8 Views and sectional views of an eighth embodiment example of a cutting machine knife according to the invention;

FIG. 1 shows a first embodiment example of a cutting machine knife 100. The cutting knife is relatively thin and consists typically of metal. The cutting machine knife 100 has a cutting body 101 and a fastening section 102 at which the cutting machine knife 100 can be fastened to a rotary drive. Starting from the rotation axis RA of the rotary drive, that is, also of the cutting machine knife 100, the fastening section 102 is situated radially to the inside, the cutting body 101 correspondingly radially to the outside.

The cutting body 101 is integrally connected to the fastening section 102 and has two flat faces 108 and 109, a convexly curved front edge 103, a concavely curved rear edge 104 and an outer edge 105. The geometry of the cutting body 101 is sickle-shaped.

The convex front edge 103 is—while the cutting machine knives 100 are in operation—at the front and the concave rear edge, correspondingly, at the rear. On the outside of the end of the cutting machine knife 100 distal from the rotation axis RR is located the outer edge 105 of the cutting body 101, which has the shape of an arc, the midpoint of which is the rotation axis RA. The cutting body 101 tapers in radial direction, such that at the transition to the fastening section 102 it is approximately four times as broad as at its oppositely-situated radial end on the outer edge 105.

The front side—in relation to a rotation direction RR intended in operation—of the cutting body 101 is its end side 106. Correspondingly, the rear side—in relation to a rotation direction RR intended in operation—of the cutting body 101 is its rear side 107.

The fastening section 102 also has two flat faces 110 and 111, which run in each case at least approximately parallel to one another and to the flat faces 108 and 109 of the cutting body 101. The axial spacing between the two flat faces 108 and 109 of the cutting body 101, i.e. the thickness D of the cutting body 101 is smaller than the thickness D of the fastening section 102 of the cutting machine knife 100.

The cutting body 101 has on its end side 106, and on its outer side starting from the outer edge 105, a ground section 112 which forms a blade with a cutting edge 113 on the cutting body 101. This ground section 112 is one-sided, i.e. the cutting body 101 is only ground on one flat face. However, this does not exclude a ground section on both sides in a further embodiment example which is not shown. A striking edge 114 on the end side 106 of the cutting body adjoins on the ground section 112, which striking edge is formed by a portion of the end side 106 which extends at a right-angle W to the flat face 109. The striking edge 114 runs, starting from the fastening section 102, along the end side 106 and the outer side, adjacent to the outer edge 105, of the cutting body 101. The rear side 107 of the cutting body 101 has a bevel F on the flat face 108 which is located opposite to the flat face 109 with the ground section 112. The bevel F extends, starting from the fastening section 102, as far as the vicinity of the outer edge 105. The bevel F has its greatest breadth approximately radially in the center of the cutting body 101 and tapers off towards its longitudinal ends.

The example of a cutting machine knife 100 shown in FIG. 1 has a number of functional elements FE for the further comminution and emulgation of the supplied material M. The functional elements FE comprise three different types of functional elements, specifically indentations 115 in the cutting body 101, breakthroughs 116 in the cutting body 101 and elevations 118 on the cutting body.

The breakthroughs 116 form openings Ö which extend from the one flat face to the other flat face 108 and 109 of the cutting body 101. Both the indentations 115 and the breakthroughs 116 have a circular geometry G. The side faces of the indentations 115 and/or of the breakthroughs 116 can extend perpendicularly or obliquely to the flat faces 108, 109 of the cutting body 101. In the shown embodiment example, the functional elements FE are all arranged on a flat face 108 of the cutting body 101, specifically on the flat face 108 which is opposite to the flat face 109 with the ground section 112.

As shown in the embodiment example of FIG. 1, each elevation 118 is shaped like an upended truncated cone. This means that the elevations 118 on the transition to the flat face assigned to the functional elements FE, the side face 126 of the cutting body 101, have a smaller cross-section than at its opposite outer face 120, facing away from this side face 126, of the respective elevation 118. This has the result that a shell face MF of the frustoconical elevations 118 encloses in each case an acute angle W with the assigned side face 126 and the elevations 118 form in each case a striking edge 117 in rotational direction RR of the cutting body 101. For reasons of the acute angle W between the shell face MF and the outer face 120 of the respective elevation 118, the peripheral edges 119 at the outer faces 120 of the elevations 118 act as additional blades S.

Starting from the assigned side face 126, the elevations 118 have in addition an axial extension which is dimensioned such that the outer faces 120 of the elevations 118 lie on the same plane as the corresponding flat face 110 of the fastening section 102. This means, the thickness D of the fastening section 102 is equal to the combined thickness D of the cutting body 101 and an elevation 118. In a further, not shown, embodiment example, the axial extension of the elevations 118 can also be larger and/or smaller than the above-described axial extension of the elevations 118. Thus, the combined thickness D of the cutting body 101 and one elevation 118 can also be larger and/or smaller than the thickness D of the fastening section 102.

The indentations 115 and the breakthroughs 116 in the cutting body 101 favor in particular the emulgation of the supplied material M, in that these functional elements FE ensure an increased turbulence of the supplied material M. The striking edges 117 of the elevations 118 facilitate in turn an increased defibration of the supplied material M, in that it ensures a—to a certain extent—rough tearing of the material M. In addition, the peripheral edges 119 of the elevations 118 ensure an additional comminution of the material M. If, for example, the supplied material M is meat or fish, fibrous particles are formed in the sausage meat by means of the action of the striking edges 114, 117, in particular the striking edges 117 of the elevations 118. This is advantageous for the bonding of the individual components in the end product. Furthermore, for reasons of an increased number of available blades 113, 119, that is by means of the additional cutting action of the peripheral edges 119 of the elevations 118, a total available blade length is increased. This results in an improved comminution of connective tissue contained in the material M, which in turn results in improved sensory properties for the end product, since the particle size of the connective tissues is reduced. By means of the turbulent sausage meat flow forming for reasons of the indentations 115 and the breakthroughs 116, in addition, the mixing and emulgation of the sausage meat is improved.

In the embodiment example shown in FIG. 1, the functional elements FE form functional groups FG in which the functional elements FE are arranged behind one another— in relation to the rotation direction RR intended in operation—in a straight row GR. Alternatively, the functional elements of a functional group can also be arranged in a curved line (not shown). In the shown embodiment example, the sequence RF of the functional elements FE, in relation to the rotation direction RR intended in operation, is such that the first functional element FE of a respective functional group FG is an indentation 115, followed by a breakthrough 116, followed in turn by an elevation 118. In a functional group of this sort, both the indentation 115 and the breakthrough 116 ensure an improved turbulence, and in addition the breakthrough 116 ensures an improved mixing of the sausage meat flow. In addition, the elevation 118 ensures a further defibration and comminution of the individual components of the sausage meat. Particularly the arrangement of breakthrough 116 and elevation 118 following one another in rotation direction RR ensures a supply of the sausage meat flow from the flat face 109 opposite the functional elements FE to the respective elevation 118. Thus, also this region of the sausage meat flow is continuously supplied to a further comminution and defibration at the elevation 118.

The previously described arrangement of the functional elements FE is thus advantageous, but not the only possible arrangement, and is thus not mandatory. For example, also a reversal of the sequence RF of the functional elements FE in a functional group FG is possible.

The functional elements FE within a functional group FG in rotation direction RR of the cutting body 101 overlap in each case partially. In the example shown in FIG. 1, the breakthrough 116 overlaps the indentation 115 to an extent to which the side, facing away from the assigned side face 126, of the frustoconical elevation 118 overlaps the breakthrough 116 in turn. In alternative embodiment variants (not shown), the functional elements FE can also have different spacings from one another in rotation direction RR of the cutting body 101. As a result, thus additional regions are introduced into the cutting body 101 which ensure an advantageous turbulence and thus an improved mixing of the sausage meat flow BS.

In addition, the embodiment example of FIG. 1 shows that the assigned side face 126 of the cutting body 101 has several functional groups FG. These functional groups FG are arranged along the convex course of the cutting edge 113. The functional groups FG are evenly spaced from one another in radial direction R of the cutting body 101.

Since the cutting body 101 is broader near the fastening spacing and tapers to the outside in radial direction, several functional elements FE and functional groups FG can be arranged in rotation direction behind one another in the vicinity of the fastening section. Specifically, this means that the arrangement of the functional groups FG and the functional elements FE contained in a respective functional group FG is dependent on the breadth B of the assigned side face 126 in rotation direction RR, and the number of the function elements FE arranged one after another is lower in the vicinity of the outer edge 105 than in the vicinity of the fastening section 102.

Here, each functional group FG has respectively at least one elevation 118, while several functional groups FG have no indentation 115 and/or no breakthrough 116.

In a not-shown embodiment example, the assigned flat face 108 of the cutting body 101 can also be arranged only a number of elevations 118 according to the concept of the invention in a pattern MU identical to, similar to or in a modification of FIG. 1.

FIG. 2 shows a second embodiment example of the cutting machine knife 100. The cutting machine knife 100 has a cutting body 101 and a fastening section 102, wherein the cutting body 101 is connected integrally with the fastening section 102 and has two flat faces 108 and 109. The geometry of the cutting body 101 is sickle-shaped. In contrast to the first embodiment example, the shown second example of a cutting machine knife 100 has no number of functional elements FE for the further comminution and emulgation of the supplied material M, specifically neither indentations 115 in the cutting body 101, nor breakthroughs in the cutting body 101, nor elevations 118 on the cutting body.

In the shown second embodiment example of a cutting machine knife 100, for the further comminution and emulgation of the supplied material M, a first striking edge 114 and a further, downstream, striking edge 124 are provided. The first striking edge 114 and the further striking edge 124 are arranged on the flat face 109 which is opposite the flat face 108 facing the sausage meat flow BS. In further embodiment examples which are not shown, further striking edges can also be provided. In the shown embodiment example, both striking edges 114, 124 run starting from the fastening section 102 along the end side 106 and in portions along the outer side, adjacent to the outer edge 105, of the cutting body 101.

The first striking edge 114 is formed by a portion of an end face 125 on the end side 106 of the cutting body 101, which runs at a right-angle W to the side face 109. The end face 125 extends perpendicularly to the rotation plane RE of the cutting machine knife 100 in relation to the intended rotation direction RR between two flat faces 122, 123 of the cutting machine knife 100. Both a transition 121 from the leading flat face 122 of the end face 125 in rotation direction RR, and a transition 121 from the end face 125 to the flat face 123 trailing this end face 125 in rotation direction RR is sharp-edged. The further downstream striking edge 124 is similar in geometrical design to the first striking edge 114. This means that the further striking edge 124 is extended between two flat faces 122, 126, in relation to the intended rotation direction RR, wherein the flat face 123 trailing the first striking edge 114 is the leading flat face 122 of the further striking edge 124. The transition 121 from the portion of the end face 125 which is assigned to the further striking edge 124 to the side face 126 of the cutting body 101 trailing this end face 125 in rotation direction RR is sharp-edged.

FIG. 3 shows a third embodiment example of the cutting machine knife 100. The cutting machine knife 100 according to the third example differs from the second embodiment example in the arrangement of the first striking edge 114 and the further, downstream, striking edge 124. Both striking edges 114, 124 are located on the flat face 108 of the cutting body 101 facing the sausage meat flow. In rotation direction RR, the side face 127 of the cutting body 101 trails the striking edge 124. Both striking edges 114, 124 are extended into the fastening section 102 of the cutting machine knife 100, analogously to the second embodiment example.

FIG. 4 shows a fourth embodiment example of the cutting machine knife 100. The cutting machine knife 100 according to the fourth example is—in relation to the arrangement of the first and the further, downstream striking edge 114, 124—a combination of the variant of the second embodiment example with the variant of the third embodiment example. This means, the embodiment example shown in FIG. 4 has both an arrangement of the first striking edge 114 and the further, downstream striking edge 124 on the flat face 109, as well as on the oppositely-situated flat face 108, facing the sausage meat flow BS, of the cutting body 101. On the flat face 109, the side face 126 of the cutting body 101 trails the striking edge 124 in rotation direction RR, on the flat face 108 the side face 127 of the cutting body 101 trails the striking edge 124 in rotation direction RR. Thus, the comminuting and emulgating performance of the cutting machine knife 100 is improved.

FIG. 5 shows a fifth embodiment example of the cutting machine knife 100. The shown embodiment example corresponds with the second embodiment example but has in addition a functional group FG with a number of functional elements FE for the further comminution and emulgation of the supplied material M. In the shown embodiment example, the functional group FG comprises an indentation 115 in the cutting body 101 and a breakthrough 116 in the cutting body 101. Both the indentation 115 and the breakthrough 116 have an approximately oval geometry G. Other geometries G can also be provided, for example a circular geometry, as shown in the first embodiment example. Moreover, in addition to or as an alternative to the functional group FG shown in this embodiment example, elevations 118 can be provided on a side face 126, 127 of the cutting body 101. It is also possible for more than one functional group FG to be provided, wherein the functional groups FG of a number of functional groups FG preferably extend along the cutting edge 113 of the cutting machine knife 100 and are evenly spaced.

Functional elements and functional groups of this sort can also be provided in the case of the cutting knife according to the third and fourth embodiment example (see FIGS. 3 and 4). Corresponding embodiment examples can be considered to be analogous to the embodiment example shown in figure, and are not shown separately in a picture.

FIG. 6 shows a further embodiment variant in which the elevations 118′ have a frustoconical geometry, wherein the elevations 118′ have a smaller diameter at the transition to the flat face 108 than at their opposite ends. This means that the frustoconical elevations 118′ are oriented with the cover surface in the direction of the corresponding flat face, the comparatively larger basic surface thus points away from the flat face of the cutting body. In the embodiment example shown in FIG. 6, only three elevations 118′ are provided. These are the only functional elements which each form a striking edge. In other embodiment variants, however, also four, five or six elevations 118′ can be provided.

FIG. 7 shows a further embodiment variant of a cutting body 100 with elevations 118″, the shape of which is equal to a preferably three-sided prism or a pyramid standing on its head, wherein the cross-sections of these elevations running parallel to the flat face 108 have a triangular shape. This triangular shape is designed such that the triangle has an acute angle which points in rotation direction of the cutting machine knife. Also in the embodiment variant shown in FIG. 7, only three elevations 118″ are provided. These are the only functional elements which each form a striking edge. In other embodiment variants, however, also four, five or six elevations 118″ can be provided.

FIG. 8 shows a further embodiment variant of a cutting body 100 with elevations 118′″ which have the shape of ribs which protrude from the flat face 108 of the cutting body 100. The rib-shaped elevations 118′″ are preferably arranged in a curve which follows at least approximately an arc, the midpoint of which is the rotation axis RA of the cutting machine knife during operation. Also in the embodiment variant shown in FIG. 8, only three elevations 118′″ are provided. These are the only functional elements which each form a striking edge. In other embodiment variants, however, also four, five or six elevations 118′″ can be provided.

### LIST OF REFERENCE SIGNS

100 cutting machine knife
101 cutting body
102 fastening section
103 convex front edge
104 concave rear edge
105 outer edge
106 end side
107 rear side
108 flat face of the cutting body
109 flat face of the cutting body
110 flat face of the fastening section
111 flat face of the fastening section
112 ground section
113 cutting edge
114 first striking edge
115 indentation
116 breakthrough
117 striking edge
118, 118″, 118′″ elevation
119 peripheral edge of the outer face of the elevations
120 outer face of the elevations
121 transition end face/flat face
122 leading flat face
123 trailing flat face
124 further striking edge
125 end face
126 side face of the cutting body
127 side face of the cutting body
BS sausage meat flow
D thickness
F bevel
FE functional element
FG functional group
G geometry
GR straight row
M material
MU pattern
O opening
RE rotation plane
RA rotation axis
RF sequence
RR rotation direction
S blade
UR peripheral direction
W angle

What is claimed is:

1. A cutting machine knife for food production, having a cutting body and a fastening section for fastening the cutting machine knife to a rotary drive, wherein the cutting body has two side faces which run at least approximately parallel to one another, and at least one knife with a cutting edge on a front edge, in relation to an intended rotation direction during operation, of the cutting body,
characterized in that the cutting body also has at least one striking edge, which is formed by an end face, which is inclined by an angle of between 60° and 120°, preferably between 70° and 90°, relative to a rotation plane of the cutting machine knife, and extends transversely to the rotation plane of the cutting machine knife in relation to the intended rotation direction between two flat faces which run at an angle between 0° and 35° to the rotation plane, wherein a transition from the end face to the flat face trailing this end face in the rotation direction is sharp-edged.

2. The cutting machine knife according to claim 1, characterized in that the cutting body has at least one elevation on a flat side, wherein the at least one elevation has a striking edge which is formed by an end face—in relation to the rotation direction intended during operation—of the at least one elevation.

3. The cutting machine knife according to claim 1, wherein on a flat side of the cutting body are arranged several elevations each forming a striking edge.

4. The cutting machine knife according to claim 3, wherein all elevations forming a striking edge are located on precisely one flat side, such that the second flat side of the cutting body has no elevations forming a striking edge.

5. The cutting machine knife according to claim 2, wherein a ground section which forms the cutting edge on the cutting body adjoins the flat side of the cutting body which has no elevations.

6. The cutting machine knife according to claim 2, wherein the elevation or the elevations have an ellipse-shaped, particularly circular or triangular cross-section in planes running parallel to the flat face.

7. The cutting machine knife according to claim 1, wherein the at least one striking edge is formed by an end face arranged—in relation to an intended rotation direction during operation—between the two flat faces and running along the knife.

8. The cutting machine knife according to claim 7, characterized in that the cutting body has a further striking edge which is geometrically similar to the first striking edge and which adjoins on the flat face trailing the first striking edge.

9. The cutting machine knife according to claim 8, wherein the first and the second flat face of the cutting body have in each case one first striking edge and one further striking edge adjoining on the flat face trailing the first striking edge.

10. The cutting machine knife according to claim 7, wherein the first striking edge and/or the further striking edge is extended along the course of the cutting edge into the fastening section of the cutting machine knife.

11. The cutting machine knife according to claim 1, wherein the flat face trailing—in the intended rotation direction—the end face forming a striking edge runs at an angle of between 0° and 5° to the rotation plane.

12. The cutting machine knife according to claim 1, wherein the cutting body has breakthroughs which form openings which run from the one flat face of the cutting body to the other.

13. The cutting machine knife according to claim 1, wherein the cutting body has indentations which are arranged on the flat face of the cutting body which faces a sausage meat flow and/or has the elevations.

14. The cutting machine knife according to claim 1, wherein in each case one elevation, one breakthrough and one indentation form functional elements of a functional groups, wherein the functional elements are arranged behind one another—in relation to the intended rotational direction during operation—in a row.

15. The cutting machine knife according to claim 1, wherein the functional groups are arranged along the course of the cutting edge hand are evenly spaced in a radial direction of the cutting body.
